(19) United States
(12) Patent Application Publication
(10) Pub. No.: US 2009/0272081 A1
(43) Pub. Date: Nov. 5, 2009

(54) Apparatus and method for packaging and dispensing medicine

(76) Inventors: Mike Panson, Pittsburgh, PA (US); Gary L. Pastore, Clearwater, FL (US)

Correspondence Address: JAMES RAY & ASSOCIATES, 2640 PITCAIRN ROAD, MONROEVILLE, PA, 15146, US

(21) Appl. No.: 12/151,012

(22) Filed: May 2, 2008

(51) Int. Cl. B65B 5/00; G06F 17/30

(52) U.S. Cl. 53/467; 700/244

(57) ABSTRACT

An apparatus for packaging and dispensing medicine includes a computerized data system for receiving and transmitting data regarding prescriptions and for tracking and recording at least one of amounts of medicine being dispensed, type of medicine being dispensed, dosage of medicine being dispensed, persons to whom medicine is being dispensed, and a combination thereof. A medicine packaging system is operably connected to such computerized data system for packaging medicine according to instructions from such computerized data system. Such medicine packaging system includes packaging having individual compartments attached in succession to each other, such packaging being disposed within such medicine packaging system for receiving individual medicine units. A dispensing mechanism is disposed within such medicine packaging system for dispensing individual medicine units into the individual compartments. A sealing mechanism is operably connected to such medicine packaging system for sealing the individual compartments to maintain the integrity of such individual medicine units.

### FIELD OF THE INVENTION

The present invention relates, in general, to medicine packaging, more particularly, this invention relates to an apparatus and method for the packaging and dispensing of medicine.

### BACKGROUND OF THE INVENTION

Prior to the conception and development of the present invention, medicine packaging, as is generally well known in the prior art, has been used to provide a user with a housing to contain medicine. Obtaining prescriptions has consisted of presenting such prescriptions at a pharmacy and waiting while a pharmacist or pharmacy technician fills such prescriptions. No systems have been implemented which allow a user to fill or refill one or more prescriptions at an automated dispenser. Furthermore, medicine packaging has generally consisted of pill bottles to hold each type of medication prescribed to a particular user. No packaging exists which contains doses of all the medicine that an individual needs for a predetermined time period.

### SUMMARY OF THE INVENTION

The present invention provides an apparatus for packaging and dispensing medicine. Such apparatus includes a computerized data system for receiving and transmitting data regarding prescriptions and for tracking and recording at least one of amounts of medicine being dispensed, type of medicine being dispensed, dosage of medicine being dispensed, persons to whom medicine is being dispensed, and a combination thereof. A medicine packaging system is operably connected to such computerized data system such that the medicine packaging system packages medicine according to instructions from such computerized data system. The medicine packaging system includes at least; packaging for such medicine including individual compartments attached in succession to each other, such packaging being operably disposed within the medicine packaging system for receiving individual medicine units, a dispensing means operably disposed within the medicine packaging system for dispensing such individual medicine units into the individual compartments, and a sealing means operably connected to the medicine packaging system for sealing the individual compartments to maintain the integrity of the individual medicine units.

In another embodiment, a method of packaging and dispensing medicine is provided. Such method includes providing a package for such medicine including a predetermined number of individual compartments each for receiving individual medicine units and each individual compartment being operably connected in succession to a next individual compartment. Dispensing such individual medicine units into such individual compartments. Sealing such individual compartments to maintain the integrity of such individual medicine units. Marking at least one of color codes and instructions on at least a portion of at least one of such sealed individual compartments such that a user will recognize at least one of a predetermined day and a predetermined time that such medicine units are to be ingested by referring to such at least one of the color codes and instructions.

### OBJECTS OF THE INVENTION

It is, therefore, one of the primary objects of the present invention to provide a system for allowing a user to fill and refill prescriptions at an automated dispenser.

Another object of the present invention is to provide a medicine dispenser that includes means for tracking the date, the time, the number and type of pills dispensed, the dosage dispensed and the person to whom the medicine is dispensed.

Still another object of the present invention is to provide a means for packaging medicine in unique individual compartments.

Another object of the present invention is to provide packaging for medicine that is color coded to indicate to a user such important facts such as the day of the week and time of day that each dosage is to be ingested.

Yet another object of the present invention is to provide a means for packaging medicine which includes instructional materials on the packaging as well as warnings and caveats regarding interactions with other medications, etc.

Another object of the present invention is to provide a method for packaging medicine which includes packaging various types of medicine prescribed to user in sequential order to simplify the process of knowing when to ingest medicine.

An additional object of the present invention is to provide an easy to use cost effective method of filling and refilling prescriptions.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment, specifically illustrated is a partial view of individual medicine units dispensed into and packaged within each successive individual compartment.

FIG. 2 is a partial perspective view of the invention according to one embodiment, specifically illustrated is a partial view of individual medicine units dispensed into and packed within each successive individual compartment.

FIG. 3 is a partial perspective view of the invention according to one embodiment of the invention in which the packed medicine units are placed within a carrying case for easy storage by a user.

FIG. 4 is a partial schematic view of the invention according to one embodiment.

FIG. 5 is a partial schematic view of the invention according to one embodiment wherein a printer is connected to the medicine packaging system.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

Reference is now made, more particularly, to FIGS. 1-5.

An apparatus, generally designated 10, for packaging and dispensing medicine is provided. Such apparatus 10 includes a computerized data system 12 for receiving and transmitting data regarding prescriptions and for tracking and recording at least one of amounts of medicine being dispensed, type of medicine being dispensed, dosage of medicine being dispensed, persons to whom medicine is being dispensed, and a combination thereof.

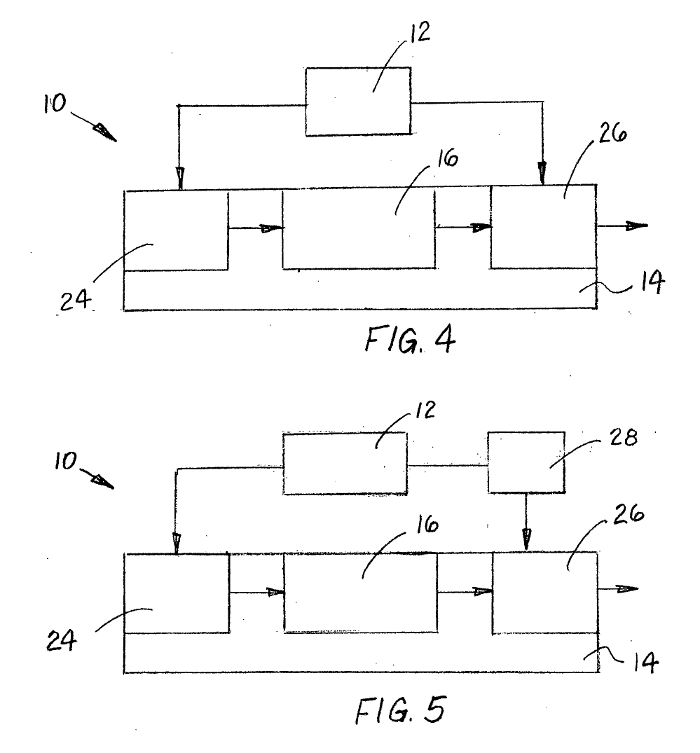

As illustrated in FIG. 4, a medicine packaging system, generally designated 14, is operably connected to such computerized data system 12 such that the medicine packaging system 14 packages medicine according to instructions from such computerized data system 14. The medicine packaging system 14 includes at least: packaging 16 for such medicine including individual compartments 18 attached in succession to each other, such packaging 16 being operably disposed within the medicine packaging system 14 for receiving individual medicine units 22, a dispensing means 24 operably disposed within such medicine packaging system 14 for dispensing the individual medicine units 22 into such individual compartments 18, and a sealing means 26 operably connected to such medicine packaging system 14 for sealing such individual compartments 18 to maintain the integrity of such individual medicine units 22.

As illustrated in FIG. 5, it is presently preferred that a color printer 28 is operably connected to such medicine packaging system 14 and such computer data system 12 for receiving predetermined information from such computer data system 12 and for printing at least a portion of the predetermined information on at least a portion of each of such individual compartments 18. It is further presently preferred that such predetermined information for printing includes at least one of color codes, instructions, and warnings. Such color codes and instructions may be used such that a user will recognize at least one of a predetermined day and a predetermined time that such medicine units are to be ingested by referring to such at least one of such color codes and such instructions.

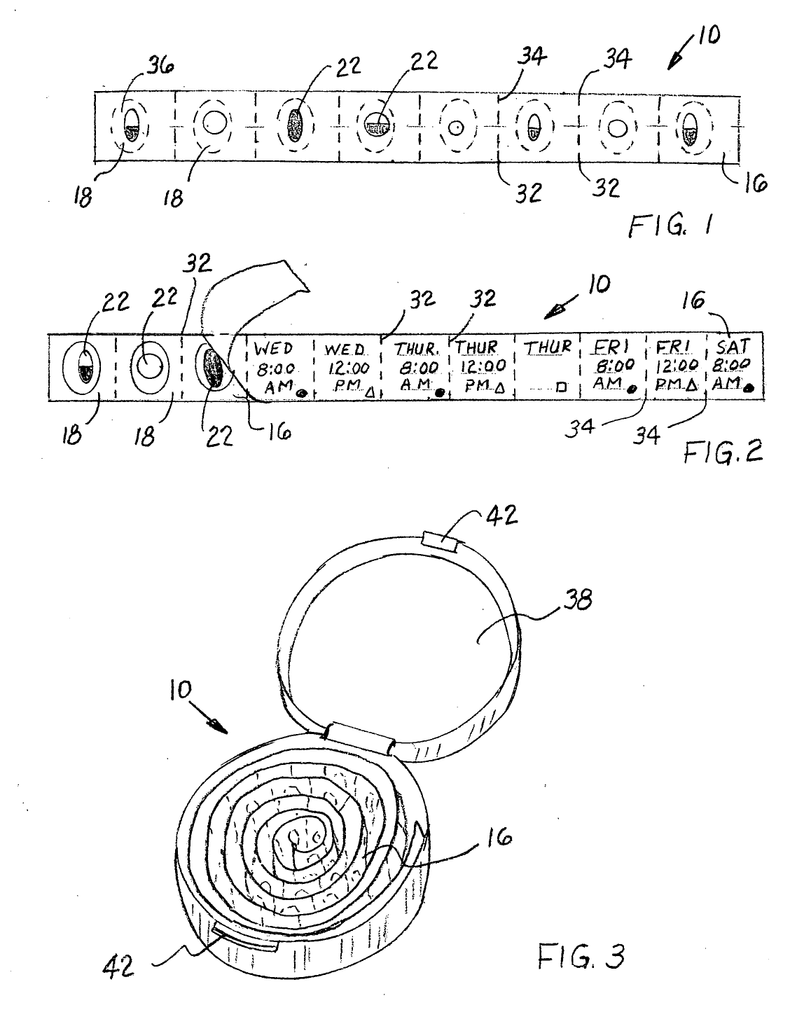

It is presently preferred that such packaging 16 includes a separating means 32 disposed on such packaging 16 at a predetermined location thereon for separating a predetermined number of such individual compartments 18 containing such medicine units 22 from a remaining number of such individual compartments 18 containing such medicine units 22. As illustrated in FIGS. 1-2, it is presently most preferred that such separating means 32 is perforations 34 disposed on such packaging 16 at predetermined locations thereon.

It is presently preferred that such individual compartments 18 include a transparent portion 36 at a predetermined location thereon.

Referencing FIG. 3, it is presently preferred that such packaging 16 further includes a carrying case 38 for use by such user for storing a predetermined number of such individual compartments 18 containing such medicine units 22. It is further presently preferred that such carrying case 38 includes a child resistant locking means 42 disposed thereon at a predetermined location.

It is presently preferred that such individual medicine units 22 are dispensed in a predetermined order into each successive individual compartment 18 for sequential ingestion by such user.

According to another embodiment, a method of packaging and dispensing medicine is provided. Such method includes providing a package for such medicine including a predetermined number of individual compartments each for receiving individual medicine units and each individual compartment being operably connected in succession to a next individual compartment.

Dispensing such individual medicine units into such individual compartments. Sealing such individual compartments to maintain the integrity of such individual medicine units.

Marking at least one of color codes and instructions on at least a portion of at least one of such sealed individual compartments such that a user will recognize at least one of a predetermined day and a predetermined time that such medicine units are to be ingested by referring to such at least one of such color codes and such instructions.

It is presently preferred that such method further includes providing a carrying case for use by such user for storing a predetermined number of such individual compartments containing such medicine units. It is further presently preferred that such method further includes providing a child resistant locking means disposed on such carrying case at a predetermined location thereon.

It is presently preferred that such method further includes dispensing such individual medicine units in a predetermined order into each successive individual compartment for sequential ingestion by such user.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An apparatus for packaging and dispensing medicine comprising:
(a) a computerized data system for receiving and transmitting data regarding prescriptions and for tracking and recording at least one of amounts of medicine being dispensed, type of medicine being dispensed, dosage of medicine being dispensed, persons to whom medicine is being dispensed, and a combination thereof; and
(b) a medicine packaging system operably connected to said computerized data system such that said medicine packaging system packages medicine according to instructions from said computerized data system, said medicine packaging system including at least;
i. packaging for such medicine including individual compartments attached in succession to each other, said packaging being operably disposed within said medicine packaging system for receiving individual medicine units;
ii. a dispensing means operably disposed within said medicine packaging system for dispensing said individual medicine units into said individual compartments; and
iii. a sealing means operably connected to said medicine packaging system for sealing said individual compartments to maintain the integrity of said individual medicine units.

2. An apparatus for packaging and dispensing medicine according to claim 1 wherein a color printer is operably connected to said medicine packaging system and said computer system for receiving predetermined information from said computer system and for printing at least a portion of said predetermined information on at least a portion of each of said individual compartments.

3. An apparatus for packaging and dispensing medicine according to claim 2 wherein said predetermined information for printing includes at least one of color codes, instructions, and warnings.

4. An apparatus for packaging and dispensing medicine according to claim 1 wherein said packaging includes a separating means disposed on said packaging at a predetermined location thereon for separating a predetermined number of said individual compartments containing such medicine units from a remaining number of said individual compartments containing such medicine units.

5. An apparatus for packaging and dispensing medicine according to claim 4 wherein said separating means is perforations disposed on said packaging at predetermined locations thereon.

6. An apparatus for packaging and dispensing medicine according to claim 1 wherein said packaging further includes a carrying case for use by such user for storing a predetermined number of said individual compartments containing such medicine units.

7. An apparatus for packaging and dispensing medicine according to claim 6 wherein said carrying case includes a child resistant locking means disposed thereon at a predetermined location.

8. An apparatus for packaging and dispensing medicine according to claim 1 wherein said individual compartments each include a transparent portion at a predetermined location thereon.

9. An apparatus for packaging and dispensing medicine according to claim 1 wherein said individual medicine units are dispensed in a predetermined order in each successive individual compartment for sequential ingestion by such user.

10. A method of packaging and dispensing medicine, such method comprising the steps of:
a. providing a package for such medicine including a predetermined number of individual compartments each for receiving individual medicine units and each individual compartment being operably connected in succession to a next individual compartment;
b. dispensing such individual medicine units into said individual compartments;
c. sealing said individual compartments to maintain the integrity of said individual medicine units; and
d. marking at least one of color codes and instructions on at least a portion of at least one of said sealed individual compartments such that a user will recognize at least one of a predetermined day and a predetermined time that said medicine units are to be ingested by referring to said at least one of said color codes and said instructions.

11. The method according to claim 10 wherein said method further includes providing a carrying case for use by such user for storing a predetermined number of said individual compartments containing such medicine units.

12. The method according to claim 11 wherein said method further includes providing a child resistant locking means disposed on said carrying case at a predetermined location thereon.

13. The method according to claim 10 wherein said method further includes dispensing said individual medicine units in a predetermined order in each successive individual compartment for sequential ingestion by such user.
